(19) United States
(12) Patent Application Publication
(10) Pub. No.: US 2024/0236342 A1
(43) Pub. Date: Jul. 11, 2024

(54) SYSTEMS AND METHODS FOR SCALABLE VIDEO CODING FOR MACHINES

(71) Applicant: OP Solutions, LLC, Amherst, MA (US)

(72) Inventors: Hari Kalva, BOCA RATON, FL (US); Borivoje Furht, BOCA RATON, FL (US); Velibor Adzic, CANTON, GA (US)

(21) Appl. No.: 18/615,060

(22) Filed: Mar. 25, 2024

Related U.S. Application Data
(63) Continuation of application No. PCT/US2022/044968, filed on Sep. 28, 2022.
(60) Provisional application No. 63/249,984, filed on Sep. 29, 2021.

(51) Int. Cl. H04N 19/30; H04N 19/70; H04N 19/85

(52) U.S. Cl. CPC H04N 19/30; H04N 19/70; H04N 19/85

(57) ABSTRACT

Systems and methods for scalable video coding for machines is provided. In an aspect, a decoder is provided which includes circuitry configured to receive a bitstream, the bitstream including at least a header, at least a base feature layer, and at least a residual visual layer. The decoder is configured to decode the at least a base feature layer, decode the at least a residual visual layer, combine the at least a decoded base feature layer with the at least a residual visual layer, and output a human-viewable video as a function of the combined at least a decoded base feature layer and the at least a residual visual layer.

### CROSS-REFERENCE TO RELATED APPLICATIONS

This application is a continuation of international application PCT/US22/44968 filed on Sep. 28, 2022, ant entitled SYSTEMS AND METHODS FOR SCALABLE VIDEO CODING FOR MACHINES, which in turn claims the benefit of priority to U.S. Provisional Application Ser. No. 63/249,984, filed on Sep. 29, 2021, and entitled SYSTEMS AND METHODS FOR SCALABLE VIDEO CODING FOR MACHINES, the disclosures of which are hereby incorporated by reference in their entirety.

### FIELD OF THE INVENTION

The present invention generally relates to the field of video encoding and decoding. In particular, the present invention is directed to systems and methods for organizing and searching a video database.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)'s advanced video coding (AVC) standard (also referred to as H.264). Motion compensation can describe a picture in terms of the transformation of a reference picture to the current picture. The reference picture can be previous in time when compared to the current picture, from the future when compared to the current picture. When images can be accurately synthesized from previously transmitted and/or stored images, compression efficiency can be improved.

### SUMMARY OF THE DISCLOSURE

In an aspect a decoder comprising circuitry may be configured to receive a bitstream, the bitstream including at least a header, at least a base feature layer, and at least a residual visual layer, decode the at least a base feature layer, decode the at least a residual visual layer, combine the at least a decoded base feature layer with the at least a residual visual layer, and output a human-viewable video as a function of the combined at least a decoded base feature layer and the at least a residual visual layer.

In another aspect a method of decoding, using a decoder comprising circuitry, includes receiving a bitstream, using the circuitry, the bitstream including at least a header, at least a base feature layer, and at least a residual visual layer, decoding, using the circuitry, the at least a base feature layer, decoding, using the circuitry, the at least a residual visual layer, combining, using the circuitry, the at least a decoded base feature layer with the at least a residual visual layer, and outputting, using the circuitry, a human-viewable video as a function of the combined at least a decoded base feature layer and the at least a residual visual layer.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of a video coding system;

FIG. 2 is a block diagram illustrating an exemplary embodiment of a video coding for machines system;

FIG. 3 is a block diagram illustrating an exemplary embodiment of an encoder for scalable video coding for machines;

FIG. 4 is an illustration depicting an exemplary feature map;

FIG. 5 is a block diagram illustrating an exemplary embodiment of a decoded for scalable video coding for machines;

FIG. 6 is an illustration of an exemplary bitstream for scalable video coding for machines;

FIG. 7 is an illustration of another exemplary bitstream for scalable video coding for machines;

FIG. 8 is a block diagram illustrating another exemplary embodiment of an encoder for scalable video coding for machines;

FIG. 9 is a block diagram illustrating another exemplary embodiment of a decoded for scalable video coding for machines;

FIG. 10 is a block diagram illustrating exemplary machine-learning processes;

FIG. 11 is a block diagram illustrating an exemplary embodiment of a video decoder;

FIG. 12 is a block diagram illustrating an exemplary embodiment of a video encoder;

FIG. 13A illustrates an exemplary image being encoded;

FIG. 13B is a block diagram of an exemplary encoder encoding an exemplary image;

FIG. 14 is a flow diagram illustrating an exemplary method of scalable video coding for machines; and

FIG. 15 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

In many applications, such as surveillance systems with multiple cameras, intelligent transportation, smart city applications, and/or intelligent industry applications, traditional video coding may require compression of large number of videos from cameras and transmission through a network to machines and for human consumption. Subsequently, at a machine site, algorithms for feature extraction may be applied, typically using convolutional neural networks or deep learning techniques including object detection, event action recognition, pose estimation and others.

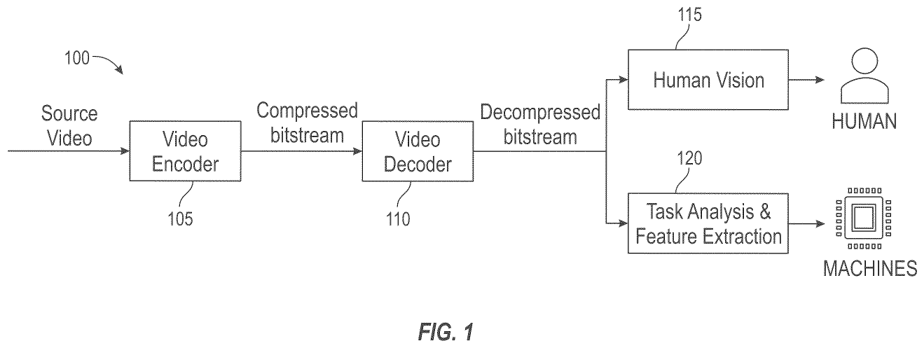

FIG. 1 shows an exemplary embodiment of a standard VVC coder applied for machines. Conventional approach unfortunately can require a massive video transmission from multiple cameras, which may take significant time for efficient and fast real-time analysis and decision-making. In embodiments, a VCM approach may resolve this problem by both encoding video and extracting some features at a transmitter site and then transmitting a resultant encoded bit stream to a VCM decoder. As illustrated in FIG. 1, the system generally includes a video encoder 105 which provides a compressed bitstream over a channel to video decoder 110. In a hybrid system the video decoder is coupled to both a conventional decoder video for human consumption 115 and task analysis and feature extraction 120 for machine consumption. At a decoder site video may be decoded for human vision and features may be decoded for machines.

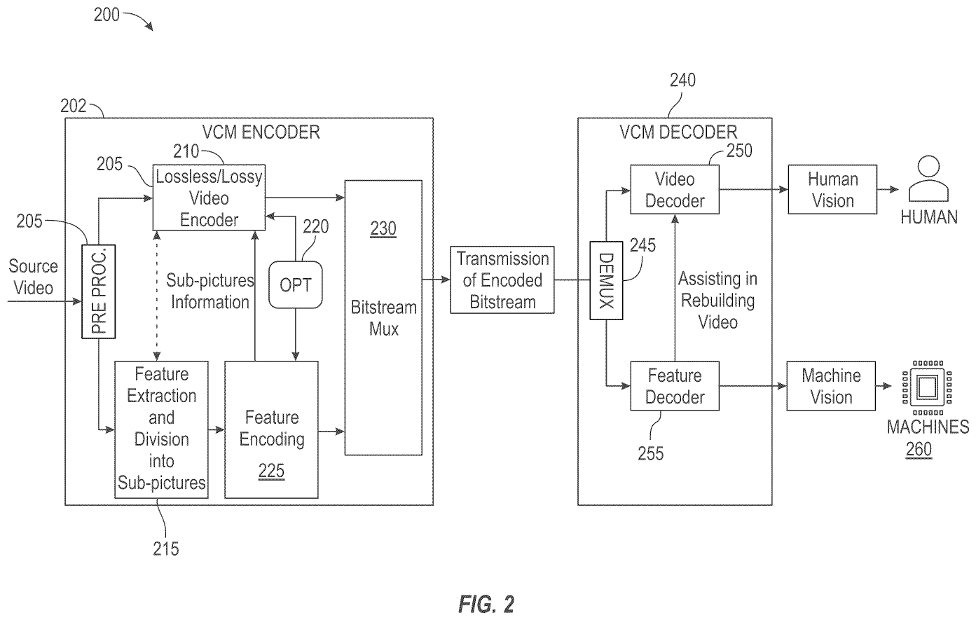

Referring now to FIG. 2, an exemplary embodiment of encoder for video coding for machines (VCM) is illustrated. VCM encoder may be implemented using any circuitry including without limitation digital and/or analog circuitry; VCM encoder may be configured using hardware configuration, software configuration, firmware configuration, and/or any combination thereof. VCM encoder may be implemented as a computing device and/or as a component of a computing device, which may include without limitation any computing device as described below. In an embodiment, VCM encoder may be configured to receive an input video and generate an output bitstream. Reception of an input video may be accomplished in any manner described below. A bitstream may include, without limitation, any bitstream as described below.

VCM encoder may include, without limitation, a pre-processor, a video encoder, a feature extractor, an optimizer, a feature encoder, and/or a multiplexor. Pre-processor may receive input video stream and parse out video, audio and metadata sub-streams of the stream. Pre-processor may include and/or communicate with decoder as described in further detail below; in other words, Pre-processor may have an ability to decode input streams. This may allow, in a non-limiting example, decoding of an input video, which may facilitate downstream pixel-domain analysis.

Further referring to FIG. 2, VCM encoder may operate in a hybrid mode and/or in a video mode; when in the hybrid mode VCM encoder may be configured to encode a visual signal that is intended for human consumers, to encode a feature signal that is intended for machine consumers; machine consumers may include, without limitation, any devices and/or components, including without limitation computing devices as described in further detail below. Input signal may be passed, for instance when in hybrid mode, through pre-processor 205.

Still referring to FIG. 2, video encoder 210 may include without limitation any video encoder as described in further detail below. When VCM encoder 202 is in hybrid mode, VCM encoder 202 may send unmodified input video to video encoder and a copy of the same input video, and/or input video that has been modified in some way, to feature extractor. Modifications to input video may include any scaling, transforming, or other modification that may occur to persons skilled in the art upon reviewing the entirety of this disclosure. For instance, and without limitation, input video may be resized to a smaller resolution, a certain number of pictures in a sequence of pictures in input video may be discarded, reducing framerate of the input video, color information may be modified, for example and without limitation by converting an RGB video might be converted to a grayscale video, or the like.

Still referring to FIG. 2, video encoder 210 and feature extractor 215 are connected and might exchange useful information in both directions. For example, and without limitation, video encoder 210 may transfer motion estimation information to feature extractor 215, and vice-versa. Video encoder 210 may provide Quantization mapping and/or data descriptive thereof based on regions of interest (ROI), which video encoder and/or feature extractor may identify, to feature extractor, or vice-versa. Video encoder 210 may provide to feature extractor 215 data describing one or more partitioning decisions based on features present and/or identified in input video, input signal, and/or any frame and/or subframe thereof; feature extractor may provide to video encoder data describing one or more partitioning decisions based on features present and/or identified in input video, input signal, and/or any frame and/or subframe thereof. Video encoder feature extractor may share and/or transmit to one another temporal information for optimal group of pictures (GOP) decisions. Each of these techniques and/or processes may be performed, without limitation, as described in further detail below.

With continued reference to FIG. 2, feature extractor 215 may operate in an offline mode or in an online mode. Feature extractor 215 may identify and/or otherwise act on and/or manipulate features. A “feature,” as used in this disclosure, is a specific structural and/or content attribute of data. Examples of features may include SIFT, audio features, color hist, motion hist, speech level, loudness level, or the like. Features may be time stamped. Each feature may be associated with a single frame of a group of frames. Features may include high level content features such as timestamps, labels for persons and objects in the video, coordinates for objects and/or regions-of-interest, frame masks for region-based quantization, and/or any other feature that may occur to persons skilled in the art upon reviewing the entirety of this disclosure. As a further non-limiting example, features may include features that describe spatial and/or temporal characteristics of a frame or group of frames. Examples of features that describe spatial and/or temporal characteristics may include motion, texture, color, brightness, edge count, blur, blockiness, or the like. When in offline mode, all machine models as described in further detail below may be stored at encoder and/or in memory of and/or accessible to encoder. Examples of such models may include, without limitation, whole or partial convolutional neural networks, keypoint extractors, edge detectors, salience map constructors, or the like. When in online mode one or more models may be communicated to feature extractor by a remote machine in real time or at some point before extraction.

Still referring to FIG. 2, feature encoder 225 is configured for encoding a feature signal, for instance and without limitation as generated by feature extractor. In an embodiment, after extracting the features feature extractor 215 may pass extracted features to feature encoder 225. Feature encoder 225 may use entropy coding and/or similar techniques, for instance and without limitation as described below, to produce a feature stream, which may be passed to multiplexor 230. Video encoder 210 and/or feature encoder 225 may be connected via optimizer 220. Optimizer 220 may exchange useful information between those video encoder and feature encoder. For example, and without limitation, information related to codeword construction and/or length for entropy coding may be exchanged and reused, via optimizer 220, for optimal compression.

In an embodiment, and continuing to refer to FIG. 2, video encoder 210 may produce a video stream; video stream may be passed to multiplexor 230. Multiplexor 230 may multiplex video stream with a feature stream generated by feature encoder; alternatively or additionally, video and feature bitstreams may be transmitted over distinct channels, distinct networks, to distinct devices, and/or at distinct times or time intervals (time multiplexing). Each of video stream and feature stream may be implemented in any manner suitable for implementation of any bitstream as described in this disclosure. In an embodiment, multiplexed video stream and feature stream may produce a hybrid bitstream, which may be is transmitted as described in further detail below.

Still referring to FIG. 2, where VCM encoder is in video mode, VCM encoder may use video encoder 210 for both video and feature encoding. Feature extractor 215 may transmit features to video encoder 210. The video encoder 210 may encode features into a video stream that may be decoded by a corresponding video decoder 250. It should be noted that VCM encoder may use a single video encoder for both video encoding and feature encoding, in which case it may use different set of parameters for video and features; alternatively, VCM encoder may two separate video encoders, which may operate in parallel.

Still referring to FIG. 2, system may include and/or communicate with, a VCM decoder 240. VCM decoder and/or elements thereof may be implemented using any circuitry and/or type of configuration suitable for configuration of VCM encoder as described above. VCM decoder may include, without limitation, a demultiplexor 245. Demultiplexor 245 may operate to demultiplex bitstreams if multiplexed as described above; for instance and without limitation, demultiplexor may separate a multiplexed bitstream containing one or more video bitstreams and one or more feature bitstreams into separate video and feature bitstreams.

Continuing to refer to FIG. 2, VCM decoder may include a video decoder 250. Video decoder 250 may be implemented, without limitation in any manner suitable for a decoder as described in further detail below. In an embodiment, and without limitation, video decoder 250 may generate an output video, which may be viewed by a human or other creature and/or device having visual sensory abilities.

Still referring to FIG. 2, VCM decoder may include a feature decoder 255. In an embodiment, and without limitation, feature decoder 255 may be configured to provide one or more decoded data to a machine 260. Machine 260 may include, without limitation, any computing device as described below, including without limitation any microcontroller, processor, embedded system, system on a chip, network node, or the like. Machine may operate, store, train, receive input from, produce output for, and/or otherwise interact with a machine model as described in further detail below. Machine 260 may be included in an Internet of Things (IOT), defined as a network of objects having processing and communication components, some of which may not be conventional computing devices such as desktop computers, laptop computers, and/or mobile devices. Objects in IoT may include, without limitation, any devices with an embedded microprocessor and/or microcontroller and one or more components for interfacing with a local area network (LAN) and/or wide-area network (WAN); one or more components may include, without limitation, a wireless transceiver, for instance communicating in the 2.4-2.485 GHz range, like BLUETOOTH transceivers following protocols as promulgated by Bluetooth SIG, Inc. of Kirkland, Wash, and/or network communication components operating according to the MODBUS protocol promulgated by Schneider Electric SE of Rueil-Malmaison, France and/or the ZIGBEE specification of the IEEE 802.15.4 standard promulgated by the Institute of Electronic and Electrical Engineers (IEEE). Persons skilled in the art, upon reviewing the entirety of this disclosure, will be aware of various alternative or additional communication protocols and devices supporting such protocols that may be employed consistently with this disclosure, each of which is contemplated as within the scope of this disclosure.

With continued reference to FIG. 2, each of VCM encoder and/or VCM decoder may be designed and/or configured to perform any method, method step, or sequence of method steps in any embodiment described in this disclosure, in any order and with any degree of repetition. For instance, each of VCM encoder 202 and/or VCM decoder 240 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Each of VCM encoder 202 and/or VCM decoder 240 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

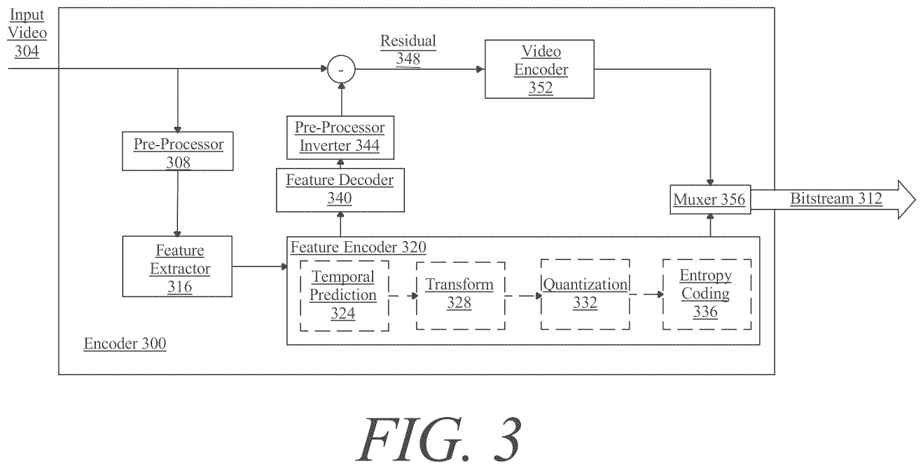

Referring now to FIG. 3, an exemplary encoder 300 for scalable video coding for machines is depicted. Encoder 300 may receive an input video 304. In some cases, encoder 300 may include a pre-processor 308. As used in this disclosure, a “pre-processor” is a component that converts information, such as without limitation an image, a video, a feature map, and the like, into a representation suitable for subsequent processing. Pre-processor 308 may convert input video 304 into a representation suitable for feature extraction. Pre-processor 308 may include any pre-processor described in this disclosure, for example with reference to FIG. 2. In some cases, to achieve this end, pre-processor 308 may reduce spatial and/or temporal resolution of video. Reduced spatial and/or temporal resolution may reduce complexity of subsequent processing. An exemplary non-limiting pre-processor 308 includes a down-scaler, which reduces resolution of input video 304, for instance by a given factor. For example, an exemplary down-scaler 308 can take as input 1920×1080 pixel video and scale it down to 1280×720 pixel video. In another example, a down-scaler 308 can take as input a 50 frames-per-second video and produce a 25 frames-per-second video, for instance by removing every other frame. Pre-processor 308 may use any pre-determined filters. In some cases, pre-processor parameters, for example filter coefficients, may be available for both encoder 300 and decoder 500. Coefficients can be implicitly or explicitly signaled by encoder 300, for example as part of a bitstream 312 header. Pre-processor 308 may not be limited to use of filters. In some cases, pre-processor 308 may apply any function (e.g., a standard-compliant function). Pre-processor parameters may be associated with any function. Pre-processor parameters may be signaled to decoder 500, for instance either implicitly or explicitly. Pre-processor parameters may be signaled by way of bitstream 312.

With continued reference to FIG. 3, pre-processed video from pre-processor 308 may be input to a feature extractor 316. As used in this disclosure, a “feature extractor” is a component that determines, extracts, or recognizes features within information, such as without limitation a picture and/or a video. In some cases, feature extractor 316 may transform pre-processed video input into feature space. In some cases, pre-processed video may be represented in a pixel domain. In some cases, feature extractor 316 may transform pre-processed video into features. Features may include any features described in this disclosure. In some cases, features may be salient for a machine task. For example, feature extractor 316 may include without limitation a simple edge detector, face detector, color detector, and the like. Alternatively or additionally, feature extractor 316 may include a more complex system that is modeled for more complicated tasks, such as without limitation object detection, motion tracking, event detection, and the like. In some cases, feature extractor 316 may include a machine-learning process, such as any machine-learning process described in this disclosure. Feature extractor 316 may include a Convolutional Neural Network (CNN) which takes images as input and outputs feature maps. As used in this disclosure, a “feature map” is a representation of features, for example within a picture or video. In some cases, a feature map may be represented as matrices of values. In some cases, feature maps can be depicted as a lower resolution, usually grayscale, patches of images. In some cases, feature map may preserve some aspects of input video 304 and/or pre-processed input video and represent a certain level of information about the input video 304 and/or pre-processed input video. In some embodiments of scalable video coding for machines, preservation of information from input video 304 within feature map may be utilized to represent video signal as a sum of base feature signal and a residual signal. As used in this disclosure, a “base feature layer” is coded information representative of at least a feature within a video. As used in this disclosure, a “residual visual layer” is coded information that represents a difference between a video and another coded layer, such as without limitation at least a base feature layer and/or another residual visual layer. In some cases, dimensions of 2-dimensional (2D) output matrices from feature extractor 316 can have a similar size as an input picture input to feature extractor. Alternatively or additionally, 2D output matrices from feature extractor 316 can be smaller than an input picture. In some cases, feature maps may represent rectangular parts (i.e., patches) of an original picture, which when combined can span substantially some or all of a picture's width and height.

With continued reference to FIG. 3, encoder 300 may include a feature encoder 320. As used in this disclosure, “feature encoder” is a component that encodes features. In some cases, feature encoder may include a base feature layer. Feature encoder 320 may include any known feature encoding method or tool, for example any described in this disclosure. Exemplary encoding tools include, without limitation, temporal prediction 324, transform 328, quantization 332, and entropy coding 336.

With continued reference to FIG. 3, encoder 300 may include a feature decoder 340. As described in this disclosure, a “feature decoder” is a component that decodes features. In some cases, encoder 300 may include a feature decode 340 in order to ascertain or model what information may be available from coded features (e.g., base feature layer) at a decoder 500. In some cases, a feature decoder 340 implement within encoder may be included within a decoder model. As used in this disclosure, a “decoder model” is a component that models performance of a decoder 500 within a system, for example without limitation an encoder 300 or another decoder 500. Implementation of decoder model, in some cases, may ensure that there is no discrepancy and/or drift between one or more of input signal 304, encoded signal, and decoded signal.

With continued reference to FIG. 3, encoder 300 may include pre-processor inverter 344. As used in this disclosure, “pre-processor inverter” is a component that inversely pre-processes information, including without limitation images, videos, and the like. As used in this disclosure, “inversely pre-processing” is an act of performing an inverse of a pre-processing, i.e., undoing a pre-processing act. Pre-processor inverter 344 may implement an exact inverse of pre-processor 308. For example without limitation, pre-processor inverter 344 may upscale a down-scaled information stream by using identical filters to that applied by pre-processor 308. In some cases, pre-processor invertor 344 may be a part of a decoder model within encoder 300.

With continued reference to FIG. 3, a residual 348 may be determined from a difference between input video 304 and video elements ascertainable from coded features. In some cases, residual may be encoded into a residual visual layer, for example by a video encoder 352. Video encoder 352 may include a standard video encoder. For example, video encoder 352 may include a full implementation of a Versatile Video Coding (VVC) encoder, or a reduced-complexity version that implements a subset of VVC tools. In general, structure of video encoder 352 may be similar to that of feature encoder 320 and may for example, include one or more of temporal prediction, transform, quantization, and entropy coding.

With continued reference to FIG. 3, encoder 300 may include a multiplexer or muxer 356. As used in this disclosure, a “muxer” is a component that receives more than one signal and outputs one signal. In some cases, muxer 356 may accept as inputs coded features and coded residuals, for example at least a base feature layer and at least a residual visual layer, from feature encoder 320 and video encoder 352, respectively. Muxer 356 may combine streams into a bitstream 312 and adds necessary information to bitstream header. As used in this disclosure, “header” is an information structure that contains information related to a video component, such as without limitation at least a base feature layer and at least a residual visual layer. In some embodiments, bitstream 312 may include at least a header, at least a base feature layer, and at least a residual visual layer.

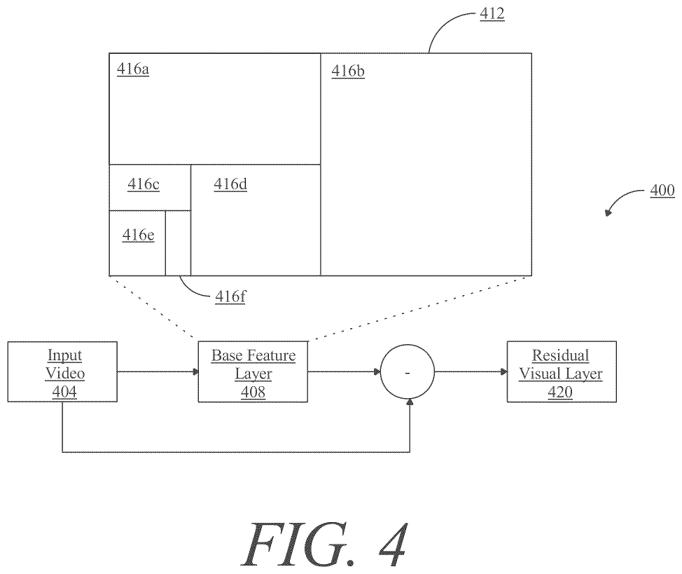

Referring to FIG. 4, exemplary information streams 400 are illustrated. An input video 404 is illustrated as an input to FIG. 4. An encoder 300 may extract and encode features from input video 404, for example yielding a base feature layer 408. As shown in FIG. 4, base feature layer 408 may include a feature map 412 (or a sequence of feature maps 412). Feature map 412 may include multiple patches 416 (for example rectangular patches) of image. In some cases, patches 416a-f may make up some are substantially all of picture frame's width and height. Finally, a residual visual layer 420 is encoded by encoder 300. Residual visual layer 420 may substantially represent visual information that is within input video 404 and not represented within base feature layer 408.

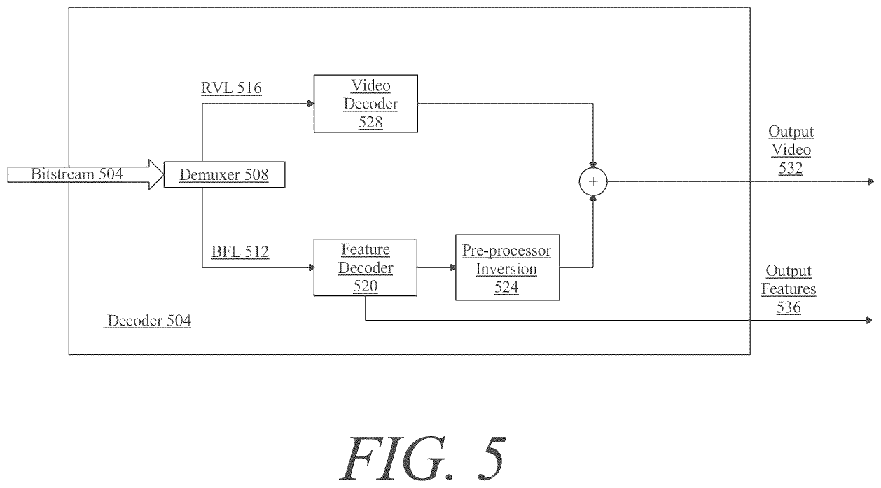

Referring now to FIG. 5, an exemplary decoder 500 for scalable video coding for machines is illustrated by way of a block diagram. In some cases, decoder 500 may include components that compute inverse operations of encoder 300, for example without limitation entropy decoding, inverse quantization, inverse transform, and residual addition. Decoder 500 may receive a bitstream 504. Bitstream may include at least a header, at least a base feature layer, and at least a residual visual layer.

With continued reference to FIG. 5, decoder 500 may include a demultiplexer or demuxer 508. As used in this disclosure, a “demuxer” is a component that takes in a single signal and outputs multiple signals. In some cases, demuxer 508 may take bitstream 504 as an input and parses and split out base feature layer (BFL) 512 and at least a residual visual layer (RVL) 516. In some cases, information about how many streams are present in bitstream 504 may be stored in bitstream header. Header may also be parsed by demuxer 508.

With continued reference to FIG. 5, decoder 500 may include a feature decoder 520. As described above, feature decoder 520 may decode any coded features, such as base feature layer 512. Feature decoder 520 may inverse at least a process that is performed by feature encoder 320. Feature decoded 520 may perform without limitation one or more of entropy decoding, inverse quantization, inverse transform, and residual addition. Output of feature decoder 520 may be passed to pre-processor inverter 524.

With continued reference to FIG. 5, decoder 500 may include a pre-processor inverter 524. Pre-processor inverter 524 may implement an inverse of functions performed by pre-processor 308. In some cases, both pre-processor 308 and pre-processor inverter 524 may use substantially similar parameters. Pre-processor parameters may be signaled explicitly or implicitly within header in bitstream 504. For example, in some cases without limitation, pre-processor inverter 524 upscale a down-scaled feature stream by using substantially similar filters to those applied by pre-processor 308 during encoding. In some cases, video decoder 528 may decode coded residual information, such as at least a RVL 516. In some cases, video decoder 528 may include a standard video decoder, such as a VVC decoder with a full or a limited set of tools.

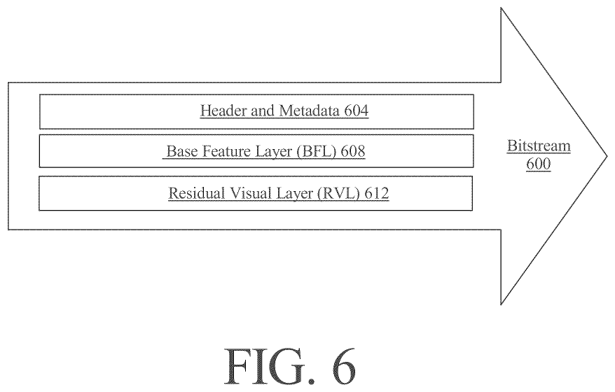

With continued reference to FIG. 6, decoder 500 may sum at least a decoded RVL is with a decoded BFL to produce an output video 532. In some cases, output video 532 may be a human-viewable video. As used in this disclosure, a “human-viewable video” is a video stream that is suitable for human viewing, i.e., human consumption and not machine consumption.

Still referring to FIG. 5, in some embodiments, decoder 500 may output at least a decoded base feature layer as output features 536. In some cases, output features 536 may be output to at least a machine. In some cases, at least a machine may be processing according to one or more algorithms, including for example without limitation a machine-learning process, machine-learning algorithm, and/or machine-learning model. In some cases, output features 536 may be structured to be input natively into one or more algorithms of at least a machine. In some cases, bitstream may include a header. Header may signal explicitly or implicitly at least a feature parameter. In some cases, decoder 500 may output at least a feature parameter to at least a machine. Exemplary non-limiting feature parameters may include machine-learning model weightings or coefficients.

Referring now to FIG. 6, an exemplary bitstream 600 is illustrated. Bitstream 600 may communicated coded information from encoder 300 to decoder 600. Bitstream 600 may include header and metadata 604. In some cases, bitstream 600 may include information related to at least a base feature layer (BFL) and at least a residual visual layer (RVL). In some cases, header and/or metadata 604 information may be needed for parsing and/or initialization of decoder. In some cases, header and/or metadata 604 may include decoder parameters. Decoder parameters may be parsed by decoder, for example in a predetermined or certain sequence. In some cases, sequence for parsing decoder parameters from header and/or metadata 604 may be defined by a standard process. In some cases, header and/or metadata may also explicitly or implicitly signal parameters for initialization of a pre-processor component, e.g., pre-processor parameters. In addition to parameters, header and/or metadata 604 may contain metadata. Metadata may include without limitation descriptions of content, supplemental data that describes parameters of the machine model (e.g., feature parameters), and the like.

With continued reference to FIG. 6, bitstream 600 may include at least a base feature layer (BFL) 608. In some cases, BFL 608 may contain information for decoding coded features. In some cases, BFL 608 may include a feature parameter set (FPS), a model description, and other elements of a header, followed by a feature payload that contains compressed features.

With continued reference to FIG. 6, bitstream 600 may include at least a residual visual layer (RVL) 612. In some cases, RVL 612 may contain information for decoding coded features. In some cases, RVL 612 may include a residual parameter set (RPS), a model description, and other elements of a header, followed by a residual payload that contains compressed residuals. In some embodiments, bitstream may include a plurality of RVLs.

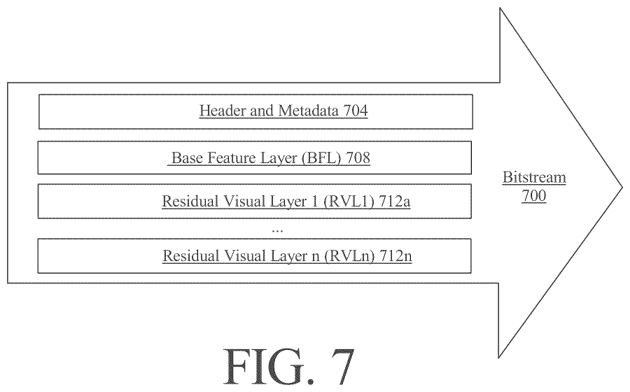

Referring now to FIG. 7, a bitstream 700 according to some embodiments is illustrated. As described above, bitstream may include header and metadata 704 and at least a base feature layer (BFL) 708. Additionally, in some cases, bitstream may include a plurality of residual visual layers (RVLs) 712a-n. In some cases, some RVLs 712a-n may be dependent upon other RVLs 712a-n. For example, in some cases, each of a lower level RVLs may be dependent of higher level RVLs. For example, RVL1 712a may be highest level and independent of other RVLs. Likewise, RVL2 may depend only on RVL1 712a and may be independent of other RVLs. RVL3 may be dependent upon RVL2 and RVL1, and so on. Depending on the application, decoder 500 may decide to decode fewer than all encoded RVLs 712a-n, or RVLs only to a certain level. In some cases, selectable levels of RVL decoding allows flexibility in choosing a proper tradeoff between a level of details in an output signal and complexity of decoding.

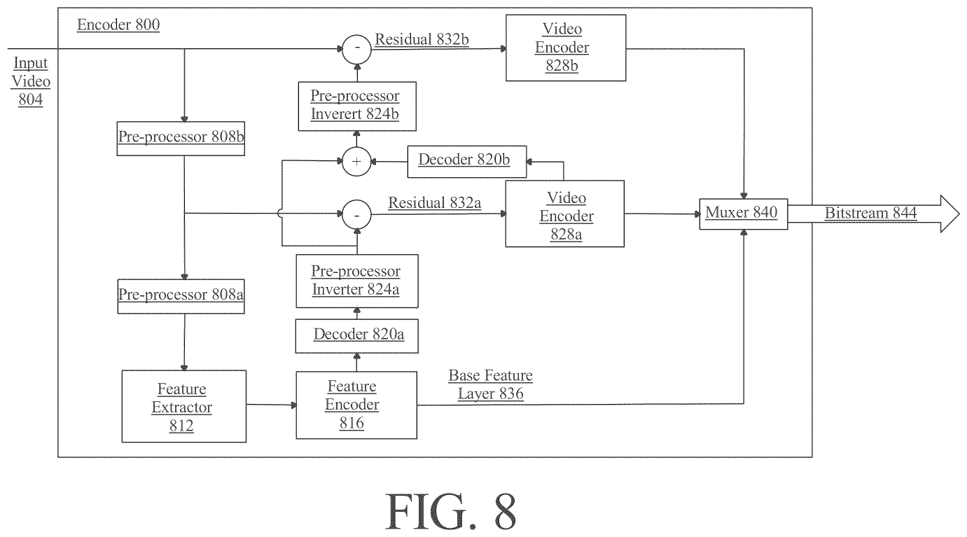

Referring now to FIG. 8, an exemplary encoder 800 for multiple RVL encoding is illustrated by way of a block diagram. As shown in FIG. 8, encoder 800 may be configured to encode two RVLs. An input video 804 may be input to encoder 800. At least a pre-processor 808a-b may pre-process input video 804, according to any processing methods described in this disclosure. Encoder 800 may include a feature extractor 812 and a feature encoder 816. Feature extractor 812 may include any feature extractor described in this disclosure. Feature encoder 816 may include any feature encoder described in this disclosure. Encoder 800 may include at least a decoder 820a-b,at least a pre-processor inverter 824a-b, and at least a video encoder 828a-b. At least a decoder 820a-b may include any decoder described in this disclosure. At least a pre-processor inverter 824a-b may include any pre-processor inverter described in this disclosure. At least a video encoder 828a-b may include any video encoder described in this disclosure. In some cases, a number of pre-processors 808a-b, decoders 820a-b, pre-processor inverter 824a-b, and/or video encoders 828a-b may be approximately equal to number of RVLs being encoded. For instance, encoder 800 may have a first pre-processor 808a, decoder 820a, pre-processor inverter 824a, and video encoder 828a for encoding a first residual 832a and a second pre-processor 808b, second decoder 820b, second pre-processor inverter 824b, and second video encoder 828b for encoding a second residual 832b. For example, in some cases, a base feature layer 836 may be encoded by feature encoder 816. Base feature layer 836 may be decoded by first decoder 820a, pre-processor inverted by first pre-process inverter 824a, and subtracted from a pre-processed input video 808b. A resulting first residual 832a may be encoded by first video encoder 828a to a first residual visual layer. First residual layer may in some cases, be input to a second decoder 820b. In some cases, output from second decoder 820b may be combined with output from one or more of first decoder 820a and/or first pre-processor inverter 824a. Combined signal may then be pre-processed and/or inverted by a second pre-process inverter 824b. Output from second pre-processor inverter 824b may be subtracter from input video 804 to yield second residual 832b. Second residual 832b may be encoded by second video encoder 828b to produce second residual visual layer. First residual visual layer, second residual visual layer, base feature layer 836, and/or at least a header may be combined by a muxer 840 into a bitstream 844.

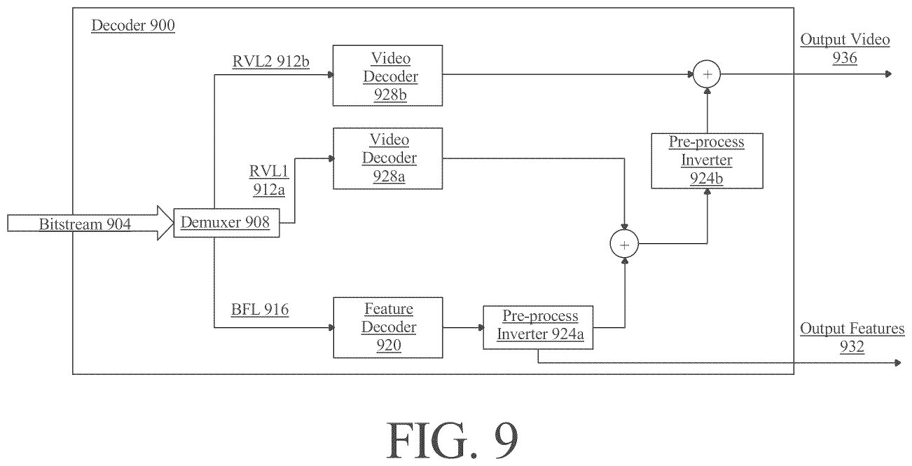

Referring now to FIG. 9, an exemplary decoder 900 for multiple RVL decoding is illustrated by way of a block diagram. As shown in FIG. 9, decoder 900 may be configured to decode a bitstream having 2 RVLs. Decoder 900 may receive a bitstream 904. Bitstream 904 may include any bitstream described in this disclosure. Decoder 900 may include a demuxer 908 which may parse and split off residual visual layers (RVLs) 912a-b and at least a base feature layer (BFL) 916. BFL 916 may be input to a feature decoder 920. Feature decoder 920 may include any feature decoder described in this disclosure. As with encoder 800, decoder 900 may include a number of pre-process inverters 924a-b and video decoders 928a-b that is approximately equal to a number of RVLs within bitstream 904. Pre-process inverters 924a-b may include any pre-process inverters described in this disclosure. Video decoders 928a-b may include any video decoders described in this disclosure. Output from feature decoder 920 may be input into a first pre-process inverter 924a and resulting features 932 may be output, for example to a machine, computing device, or processor. Output from first pre-process inverter 924a may be combined with output from first video decoder 928a, which is input with first RVL 912a. Combined signal may be input to second pre-process invert 924b. Output from second pre-process inverter 924b may combined with decoded second residual visual layer 912b from second video decoder 928b, yielding an output video 936. Output video may be human-viewable and suitable for human consumption.

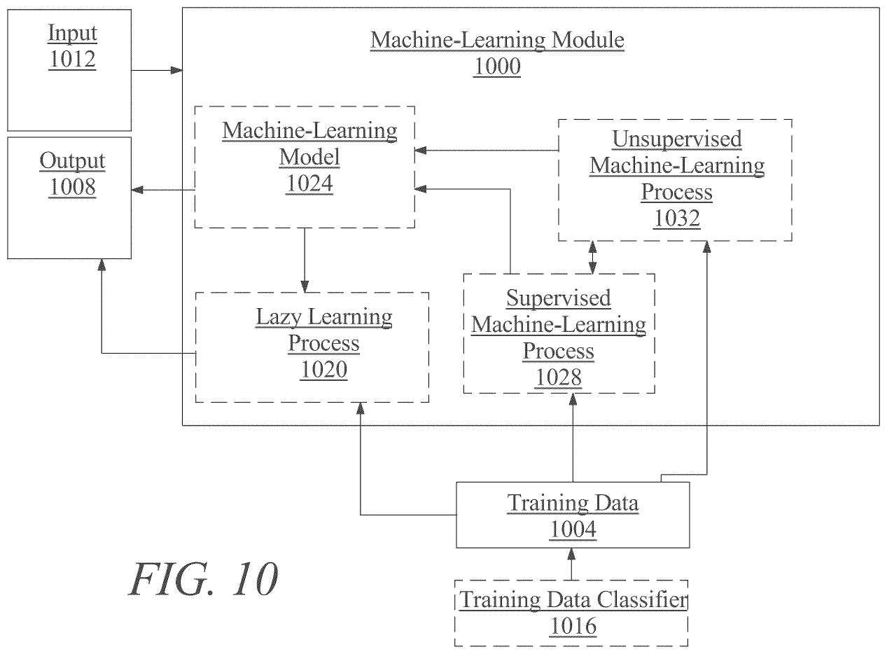

Referring now to FIG. 10, an exemplary embodiment of a machine-learning module 1000 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1004 to generate an algorithm that will be performed by a computing device/module to produce outputs 1008 given data provided as inputs 1012; this is in contrast to a non-machine learning software program where the commands to be executed are determined in advance by a user and written in a programming language.

Still referring to FIG. 10, “training data,” as used herein, is data containing correlations that a machine-learning process may use to model relationships between two or more categories of data elements. For instance, and without limitation, training data 1004 may include a plurality of data entries, each entry representing a set of data elements that were recorded, received, and/or generated together; data elements may be correlated by shared existence in a given data entry, by proximity in a given data entry, or the like. Multiple data entries in training data 1004 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1004 according to various correlations; correlations may indicate causative and/or predictive links between categories of data elements, which may be modeled as relationships such as mathematical relationships by machine-learning processes as described in further detail below. Training data 1004 may be formatted and/or organized by categories of data elements, for instance by associating data elements with one or more descriptors corresponding to categories of data elements. As a non-limiting example, training data 1004 may include data entered in standardized forms by persons or processes, such that entry of a given data element in a given field in a form may be mapped to one or more descriptors of categories. Elements in training data 1004 may be linked to descriptors of categories by tags, tokens, or other data elements; for instance, and without limitation, training data 1004 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 10, training data 1004 may include one or more elements that are not categorized; that is, training data 1004 may not be formatted or contain descriptors for some elements of data. Machine-learning algorithms and/or other processes may sort training data 1004 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1004 to be made applicable for two or more distinct machine-learning algorithms as described in further detail below. Training data 1004 used by machine-learning module 1000 may correlate any input data as described in this disclosure to any output data as described in this disclosure. As a non-limiting illustrative example, such as a feature extractor, inputs may include input video and outputs may include extracted features. Alternatively or additionally, in some cases, features may be inputs and outputs may include classifications, such as without limitation face/person detection or recognition and the like.

Further referring to FIG. 10, training data may be filtered, sorted, and/or selected using one or more supervised and/or unsupervised machine-learning processes and/or models as described in further detail below; such models may include without limitation a training data classifier 1016. Training data classifier 1016 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 1000 may generate a classifier using a classification algorithm, defined as a processes whereby a computing device and/or any module and/or component operating thereon derives a classifier from training data 1004. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1016 may classify elements of training data to function of machine using features from video, for instance surveillance, face recognition, pose estimation, and the like.

Still referring to FIG. 10, machine-learning module 1000 may be configured to perform a lazy-learning process 1020 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1004. Heuristic may include selecting some number of highest-ranking associations and/or training data 1004 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 10, machine-learning processes as described in this disclosure may be used to generate machine-learning models 1024. A “machine-learning model,” as used in this disclosure, is a mathematical and/or algorithmic representation of a relationship between inputs and outputs, as generated using any machine-learning process including without limitation any process, as described above, and stored in memory; an input is submitted to a machine-learning model 1024 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1024 may be generated by creating an artificial neural network, such as a convolutional neural network comprising an input layer of nodes, one or more intermediate layers, and an output layer of nodes. Connections between nodes may be created via the process of “training” the network, in which elements from a training data 1004 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 10, machine-learning algorithms may include at least a supervised machine-learning process 1028. At least a supervised machine-learning process 1028, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include input video as described above as inputs, extracted features as outputs, and a scoring function representing a desired form of relationship to be detected between inputs and outputs; scoring function may for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1004. Persons skilled in the art, upon reviewing the entirety of this disclosure, will be aware of various possible variations of at least a supervised machine-learning process 1028 that may be used to determine relation between inputs and outputs. Supervised machine-learning processes may include classification algorithms as defined above.

Further referring to FIG. 10, machine learning processes may include at least an unsupervised machine-learning processes 1032. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 10, machine-learning module 1000 may be designed and configured to create a machine-learning model 1024 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 10, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

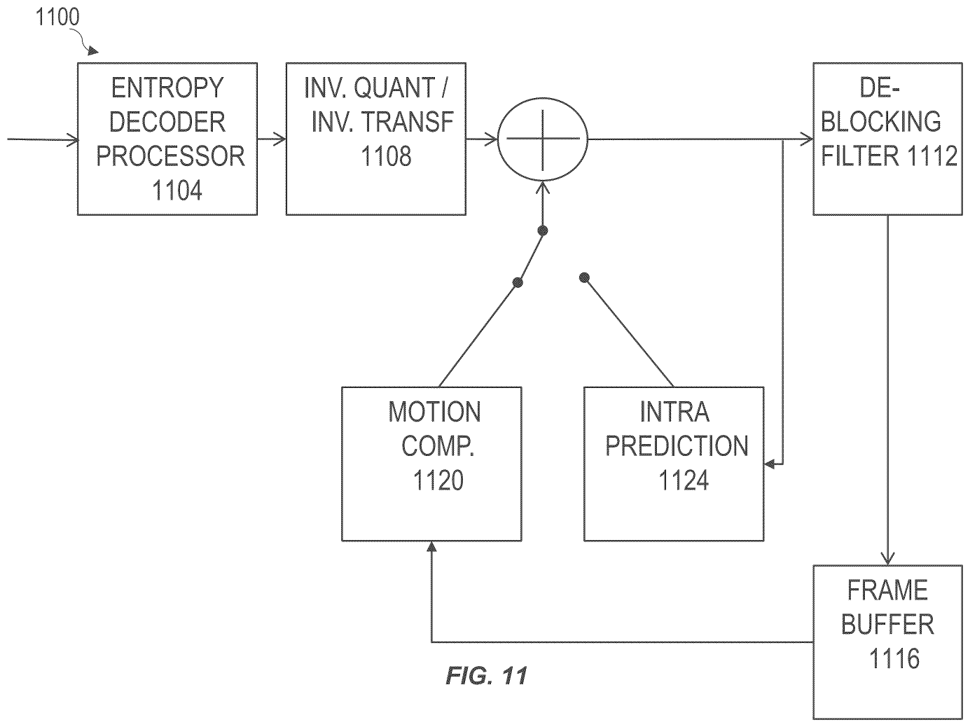

FIG. 11 is a system block diagram illustrating an example decoder 1100 capable of adaptive cropping. Decoder 1100 may include an entropy decoder processor 1104, an inverse quantization and inverse transformation processor 1108, a deblocking filter 1112, a frame buffer 1116, a motion compensation processor 1120 and/or an intra prediction processor 1124.

In operation, and still referring to FIG. 11, bit stream 1128 may be received by decoder 1100 and input to entropy decoder processor 1104, which may entropy decode portions of bit stream into quantized coefficients. Quantized coefficients may be provided to inverse quantization and inverse transformation processor 1108, which may perform inverse quantization and inverse transformation to create a residual signal, which may be added to an output of motion compensation processor 1120 or intra prediction processor 1124 according to a processing mode. An output of the motion compensation processor 1120 and intra prediction processor 1124 may include a block prediction based on a previously decoded block. A sum of prediction and residual may be processed by deblocking filter 1112 and stored in a frame buffer 1116.

In an embodiment, and still referring to FIG. 11 decoder 1100 may include circuitry configured to implement any operations as described above in any embodiment as described above, in any order and with any degree of repetition. For instance, decoder 1100 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

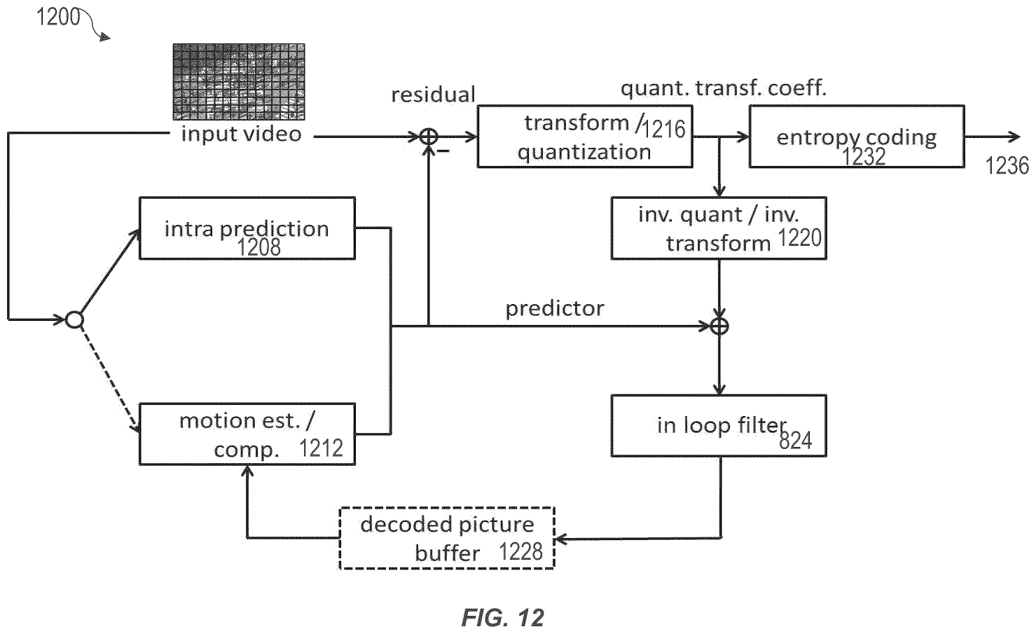

FIG. 12 is a system block diagram illustrating an example video encoder 1200 capable of adaptive cropping. Example video encoder 1200 may receive an input video 1204, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 12, example video encoder 1200 may include an intra prediction processor 1208, a motion estimation/compensation processor 1212, which may also be referred to as an inter prediction processor, capable of constructing a motion vector candidate list including adding a global motion vector candidate to the motion vector candidate list, a transform/quantization processor 1216, an inverse quantization/inverse transform processor 1220, an in-loop filter 1224, a decoded picture buffer 1228, and/or an entropy coding processor 1232. Bit stream parameters may be input to the entropy coding processor 1232 for inclusion in the output bit stream 1236.

In operation, and with continued reference to FIG. 12, for each block of a frame of input video, whether to process block via intra picture prediction or using motion estimation/compensation may be determined. Block may be provided to intra prediction processor 1208 or motion estimation/compensation processor 1212. If block is to be processed via intra prediction, intra prediction processor 1208 may perform processing to output a predictor. If block is to be processed via motion estimation/compensation, motion estimation/compensation processor 1212 may perform processing including constructing a motion vector candidate list including adding a global motion vector candidate to the motion vector candidate list, if applicable.

Further referring to FIG. 12, a residual may be formed by subtracting a predictor from input video. Residual may be received by transform/quantization processor 1216, which may perform transformation processing (e.g., discrete cosine transform (DCT)) to produce coefficients, which may be quantized. Quantized coefficients and any associated signaling information may be provided to entropy coding processor 1232 for entropy encoding and inclusion in output bit stream 1236. Entropy encoding processor 1232 may support encoding of signaling information related to encoding a current block. In addition, quantized coefficients may be provided to inverse quantization/inverse transformation processor 1220, which may reproduce pixels, which may be combined with a predictor and processed by in loop filter 1224, an output of which may be stored in decoded picture buffer 1228 for use by motion estimation/compensation processor 1212 that is capable of constructing a motion vector candidate list including adding a global motion vector candidate to the motion vector candidate list.

With continued reference to FIG. 12, although a few variations have been described in detail above, other modifications or additions are possible. For example, in some implementations, current blocks may include any symmetric blocks (8×8, 16×16, 32×32, 64×64, 128×128, and the like) as well as any asymmetric block (8×4, 16×8, and the like).

In some implementations, and still referring to FIG. 12, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 12, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 12, encoder 1200 may include circuitry configured to implement any operations as described above in any embodiment, in any order and with any degree of repetition. For instance, encoder 1200 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 1200 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 12, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 900 and/or encoder 1200 may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

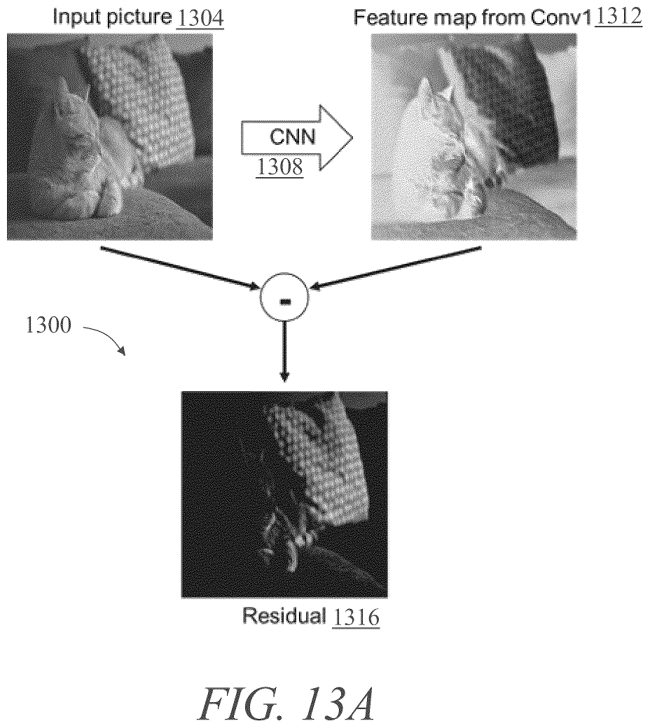

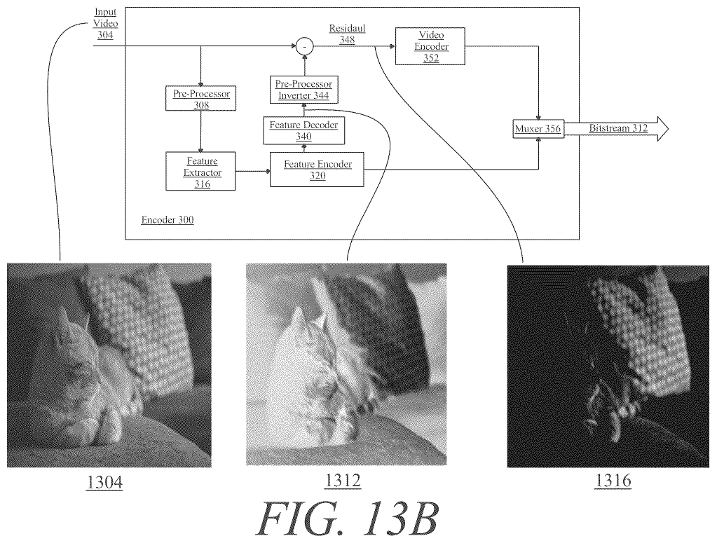

Referring now to FIG. 13A, an exemplary encoding process 1300 is illustrated. An exemplary input picture 1304 is used as input to a machine-learning process 1308. Machine-learning process 1308 may include any machine-learning process described in this disclosure, including with reference to FIGS. 1-12. In some cases, machine-learning process 1308 may include a convolutional neural network (CNN) 1308. A feature map 1312 is output from machine-learning process 1308. Feature map 1312 in some cases, may comprise a picture that results when features are decoded, for example by way of a feature decoder. In some cases, a feature map 1312 may be encoded into a base feature layer, for example as described above in reference to FIGS. 1-12. Feature map 1312 may be encoded into base feature layer, not as a map, but as an aggregate of features, which when decoded using a feature decoder yield the feature map 1312. Feature map 1312 may be subtracted from input picture 1304, yielding a residual picture 1316. In some cases, residual picture 1316 may be encoded into a residual visual layer, as described above in reference to FIGS. 1-12. According to some embodiments, a residual picture 1316 may have more homogeneous features than input picture 1304. As a result, in some cases, a residual picture 1316 may be more efficiently or easily compressed than an input picture 1304.

Referring now to FIG. 13B, an exemplary encoder 300 is illustrated in process of encoding an exemplary input picture 1304. In some cases, input picture 1308 may be included as part of an input video 304, which an encoder may receive as input. Feature map 1312 may be output from feature decoder 340. Residual picture 1316 may be generated from subtracting output from pre-processor inverter 344 from input video.

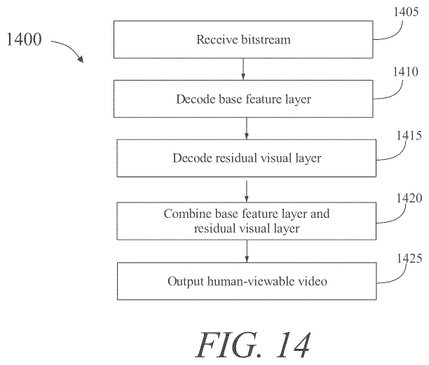

Referring now to FIG. 14, an exemplary method 1400 of decoding for scalable video coding for machines is illustrated by way of a flow diagram. At step 1405, method 1400 may include receiving a bitstream. Bitstream may include any bitstream described in this disclosure, including with reference to FIGS. 1-13B. In some cases, bitstream may include at least a header, at least a base feature layer, and at least a residual visual layer. Header may include any header described in this disclosure, including with reference to FIGS. 1-13B. Base feature layer may include any base feature layer described in this disclosure, including with reference to FIGS. 1-13B. Residual visual layer may include any residual visual layer described in this disclosure, including with reference to FIGS. 1-13B.

With continued reference to FIG. 14, at step 1410, method 1400 may include decoding at least a base feature layer. In some embodiments, step 1410 may additionally include inversely pre-processing at least a decoded base feature layer. In some cases, at least a header may include at least a pre-processing parameter and step 1410 may additionally include inversely pre-processing at least a decoded base feature layer as a function of the at least a pre-processing parameter. In some embodiments, method 1400 may additionally include outputting at least a decoded base feature layer to at least a machine. In some cases, method 1400 may include outputting at least a feature parameter, signaled in at least a header, to the at least a machine.

With continued reference to FIG. 14, at step 1415, method 1400 may include decoding at least a residual visual layer.

With continued reference to FIG. 14, at step 1420, method 1400 may include combining at least a decoded base feature layer with at least a residual visual layer.

With continued reference to FIG. 14, at step 1425, method 1400 may include outputting a human-viewable video as a function of combined at least a decoded base feature layer and at least a residual visual layer. Human-viewable video may include any human viewable video described in this disclosure, including with reference to FIGS. 1-13B.

Still referring to FIG. 14, in some embodiments, at least a residual visual layer may include a first residual visual layer and a second residual visual layer. In some cases, a number of residual visual layers may be signaled within at least a header. In some embodiments, method 1400 may additionally include combining at least a decoded base feature layer with first residual visual layer and combining the at least a combined decoded base feature and first residual visual layer with second residual visual layer.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

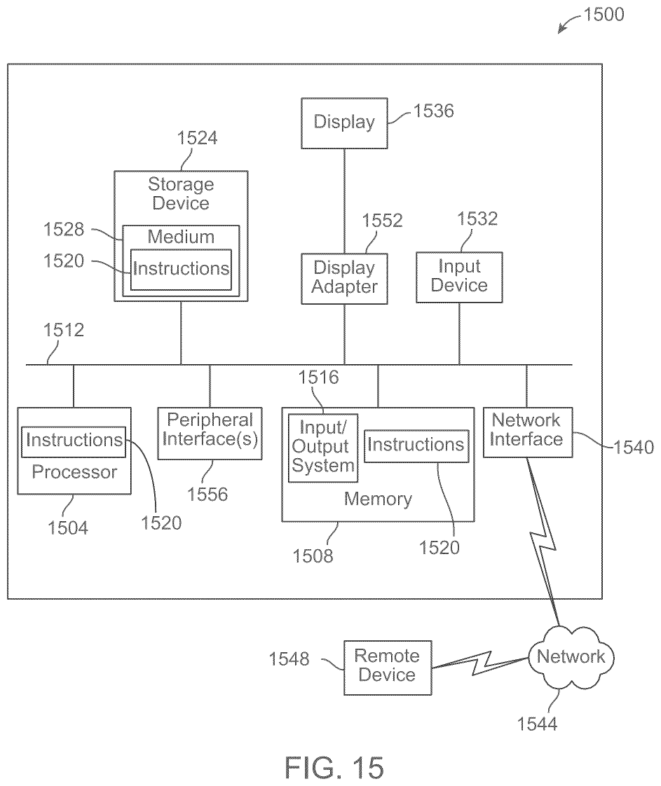

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Processor 1504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1504 may be organized according to Von Neumann and/or Harvard architecture as a non-limiting example. Processor 1504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 1508 may include various components (e.g., machine-readable media) including, but not limited to, a random-access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof.

Computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable medium 1528 may provide nonvolatile and/or volatile storage of machine-readable instructions, data structures, program modules, and/or other data for computer system 1500. In one example, software 1520 may reside, completely or partially, within machine-readable medium 1528. In another example, software 1520 may reside, completely or partially, within processor 1504.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540, may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used. Information (e.g., data, software 1520, etc.) may be communicated to and/or from computer system 1500 via network interface device 1540.

Computer system 1500 may further include a video display adapter 1552 for communicating a displayable image to a display device, such as display device 1536. Examples of a display device include, but are not limited to, a liquid crystal display (LCD), a cathode ray tube (CRT), a plasma display, a light emitting diode (LED) display, and any combinations thereof. Display adapter 1552 and display device 1536 may be utilized in combination with processor 1504 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A decoder, the decoder comprising circuitry configured to:
receive a bitstream, the bitstream including at least a header, at least a base feature layer, and at least a residual visual layer;
decode the at least a base feature layer;
decode the at least a residual visual layer;
combine the at least a decoded base feature layer with the at least a residual visual layer; and
output a human-viewable video as a function of the combined at least a decoded base feature layer and the at least a residual visual layer.

2. The decoder of claim 1, wherein decoding the at least a base feature layer further comprises inversely pre-processing the at least a decoded base feature layer.

3. The decoder of claim 2, wherein the at least a header includes at least a pre-processing parameter; and
decoding the at least a base feature layer further comprises inversely pre-processing the at least a decoded base feature layer as a function of the at least a pre-processing parameter.

4. The decoder of claim 1, wherein the at least a residual visual layer comprises a first residual visual layer and a second residual visual layer.

5. The decoder of claim 4, wherein a number of residual visual layers is signaled within the at least a header.

6. The decoder of claim 5, wherein the circuitry is further configured to combine the at least a decoded base feature later with the first residual visual layer; and
combine the at least a combined decoded base feature and first residual visual layer with the second residual visual layer.

7. The decoder of claim 1, wherein the circuitry is further configured to output the at least a decoded base feature layer to at least a machine.

8. The decoder of claim 7, wherein the circuitry is further configured to output at least a feature parameter, signaled in the at least a header, to the at least a machine.

9. The decoder of claim 7, wherein the circuitry is further configured to inversely pre-process the at least a decoded base feature layer.

10. The decoder of claim 1, wherein the circuitry is further configured to parse the bitstream into the at least a header, at least a base feature layer, and at least a residual visual layer.

11. A method of decoding, using a decoder comprising circuitry, the method comprising:
receiving a bitstream, using the circuitry, the bitstream including at least a header, at least a base feature layer, and at least a residual visual layer;
decoding, using the circuitry, the at least a base feature layer;
decoding, using the circuitry, the at least a residual visual layer;
combining, using the circuitry, the at least a decoded base feature layer with the at least a residual visual layer; and
outputting, using the circuitry, a human-viewable video as a function of the combined at least a decoded base feature layer and the at least a residual visual layer.

12. The method of claim 11, wherein decoding the at least a base feature layer further comprises inversely pre-processing, using the circuitry, the at least a decoded base feature layer.

13. The method of claim 12, wherein the at least a header includes at least a pre-processing parameter; and
decoding the at least a base feature layer further comprises inversely pre-processing the at least a decoded base feature layer as a function of the at least a pre-processing parameter.

14. The method of claim 11, wherein the at least a residual visual layer comprises a first residual visual layer and a second residual visual layer.

15. The method of claim 14, wherein a number of residual visual layers is signaled within the at least a header.

16. The method of claim 15, further comprising combining, using the circuitry, the at least a decoded base feature later with the first residual visual layer; and
combining, using the circuitry, the at least a combined decoded base feature and first residual visual layer with the second residual visual layer.

17. The method of claim 11, further comprising outputting, using the circuitry, the at least a decoded base feature layer to at least a machine.

18. The method of claim 17, further comprising outputting, using the circuitry, at least a feature parameter, signaled in the at least a header, to the at least a machine.

19. The decoder of claim 7, further comprising inversely pre-processing, using the circuitry, the at least a decoded base feature layer.

20. The decoder of claim 1, further comprising parsing, using the circuitry, the bitstream into the at least a header, the at least a base feature layer, and the at least a residual visual layer.
